(19) United States
(12) Patent Application Publication
(10) Pub. No.: US 2004/0145542 A1
(43) Pub. Date: Jul. 29, 2004

(54) Method of driving plasma display panel

(75) Inventor: Young Dae Kim, Busan-kwangyeokshi (KR)

Correspondence Address: FLESHNER & KIM, LLP, P.O. BOX 221200, CHANTILLY, VA, 20153, US

(73) Assignee: LG Electronics Inc.

(21) Appl. No.: 10/757,477

(22) Filed: Jan. 15, 2004

(30) Foreign Application Priority Data
Jan. 16, 2003 (KR) P2003-2855

(51) Int. Cl. G09G 3/28

(52) U.S. Cl. 345/60

(57) ABSTRACT

A method of driving a plasma display panel for preventing a miswriting and a misfire as well as improving a contrast is disclosed. In the method, a first waveform is applied to sustain electrodes in an initialization period included in an initial sub-field of one frame. A second waveform is applied to the sustain electrodes in an initialization period of each of the remaining sub-fields following the initial sub-field.

### BACKGROUND OF THE INVENTION

1. Field of the Invention

This invention relates to a plasma display panel, and more particularly to a method of driving a plasma display panel that is adaptive for preventing a miswriting and a misfire as well as improving a contrast.

2. Description of the Related Art

Generally, a plasma display panel (PDP) excites and radiates a phosphorus material using an ultraviolet ray generated upon discharge of an inactive mixture gas such as He+Xe, Ne+Xe or He+Ne+Xe, to thereby display a picture.

Such a PDP is easy to be made into a thin-film and large-dimension type. Moreover, the PDP provides a very improved picture quality owing to a recent technical development.

Referring to FIG. 1, a discharge cell of a conventional three-electrode, AC surface-discharge PDP includes a scan electrode 30Y and a sustain electrode 30Z provided on an upper substrate 10, and an address electrode 20X provided on a lower substrate 18. Each of the scan electrode 30Y and the sustain electrode 30Z includes transparent electrodes 12Y and 12Z, and metal bus electrodes 13Y and 13Z having smaller line widths than the transparent electrodes 12Y and 12Z and provided at one edge of the transparent electrodes 12Y and 12Z.

The transparent electrodes 12Y and 12Z are usually formed from indium-tin-oxide (ITO) on the upper substrate 10. The metal bus electrodes 13Y and 13Z are usually formed from a metal such as chrome (Cr), etc. on the transparent electrodes 12Y and 12Z to thereby reduce a voltage drop caused by the transparent electrodes 12Y and 12Z having a high resistance.

On the upper substrate 10 provided, in parallel, with the scan electrode 30Y and the common sustain electrode 30Z, an upper dielectric layer 14 and a protective film 16 are disposed. Wall charges generated upon plasma discharge are accumulated onto the upper dielectric layer 14. The protective film 16 prevents a damage of the upper dielectric layer 14 caused by a sputtering during the plasma discharge and improves the emission efficiency of secondary electrons. This protective film 16 is usually made from magnesium oxide (MgO).

A lower dielectric layer 22 and barrier ribs 24 are formed on the lower substrate 18 provided with the address electrode 20X. The surfaces of the lower dielectric layer 22 and the barrier ribs 24 are coated with a phosphorous material 26. The address electrode 20X is formed in a direction crossing the scan electrode 30Y and the sustain electrode 30Z. The barrier rib 24 is formed in parallel to the address electrode 20X to thereby prevent an ultraviolet ray and a visible light generated by a discharge from being leaked to the adjacent discharge cells. The phosphorous material 26 is excited by an ultraviolet ray generated during the plasma discharge to generate any one of red, green and blue visible light rays. An inactive mixture gas for a gas discharge is injected into a discharge space defined between the upper and lower substrate 10 and 18 and the barrier rib 24.

Such a PDP makes a time-divisional driving of one frame, which is divided into various sub-fields having a different emission frequency, so as to realize gray levels of a picture. Each sub-field is again divided into an initialization period for initializing the entire field, an address period for selecting a scan line and selecting the cell from the selected scan line and a sustain period for expressing gray levels depending on the discharge frequency. Herein, the initialization period is again divided into a set-up interval supplied with a rising ramp waveform and a set-down interval supplied with a falling ramp waveform.

For instance, when it is intended to display a picture of 256 gray levels, a frame interval equal to 1/60 second (i.e. 16.67 msec) is divided into 8 sub-fields SF1 to SF8 as shown in FIG. 2. Each of the 8 sub-field SF1 to SF8 is divided into an initialization period, an address period and a sustain period as mentioned above. Herein, the initialization period and the address period of each sub-field are equal for each sub-field, whereas the sustain period and the number of sustain pulses assigned thereto are increased at a ratio of 2ⁿ (wherein n=0, 1, 2, 3, 4, 5, 6 and 7) at each sub-field.

FIG. 3 shows a driving waveform of the PDP applied to two sub-fields. In FIG. 3, Y represents the scan electrode; Z does the sustain electrode; and X does the address electrode.

Referring to FIG. 3, the PDP is divided into an initialization period for initializing the full field, an address period for selecting a cell, and a sustain period for sustaining a discharge of the selected cell for its driving.

In the initialization period, a rising ramp waveform Ramp-up is simultaneously applied to the entire scan electrodes Y in a set-up interval. This rising ramp waveform Ramp-up causes a weak discharge within cells at the full field to generate wall charges within the cells. In the set-down interval, after the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the sustain electrodes Z during the set-down interval and the address period.

In the sustain period, a sustaining pulse sus is alternately applied to the scan electrodes Y and the sustain electrodes Z. Then, a wall voltage within the cell selected by the address discharge is added to the sustain pulse sus to thereby generate a sustain discharge taking a surface-discharge type between the scan electrode Y and the common sustain electrode Z whenever each sustain pulse sus is applied.

Finally, after the sustain discharge was finished, a erasing ramp waveform erase having a small pulse width is applied to the common sustain electrode Z to thereby erase wall charges left within the cells.

However, such a conventional PDP has a problem in that a contrast is deteriorated due to a light generated in the initialization period. More specifically, the rising ramp waveform Ramp-up supplied in the initialization period causes a discharge between the scan electrode Y and the sustain electrode Z and between the scan electrode Y and the address electrode X, thereby forming negative wall charges at the scan electrode Y while forming positive wall charges at the common sustain electrode Z as shown in FIG. 4.

At the result of an experiment, a discharge between the scan electrode Y and the sustain electrode Z is generated at a lower voltage than a discharge between the scan electrode Y and the address electrode Z. A light emission amount caused by the discharge between the scan electrode Y and the sustain electrode Z becomes larger than that caused by the discharge between the scan electrode Y and the address electrode X. Since this increases a light emission amount in the initialization period which is a non-display period, a contrast property is deteriorated to that extent.

Accordingly, in the prior art, there has been suggested a driving method as shown in FIG. 5 in order to improve a contrast property of the PDP.

FIG. 5 shows another conventional method of driving a plasma display panel.

Referring to FIG. 5, said another conventional PDP driving method is divided into an initialization period for initializing the full field, an address period for selecting a cell, and a sustain period for sustaining a discharge of the selected cell for its driving.

In the initialization period, a rising ramp waveform Ramp-up is simultaneously applied to the entire scan electrodes Y in a set-up interval. This rising ramp waveform Ramp-up causes a weak discharge within cells at the full field to generate wall charges within the cells. In the set-down interval, after the rising ramp waveform Ramp-up was raised into a peak voltage Vr, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, the sustain electrodes Z are floated. In the first half of the set-up interval when the sustain electrodes Z are supplied with a ground voltage, a discharge is generated between the scan electrodes Y and the sustain electrodes Z to thereby form wall charges within the discharge cell. In the second half of the set-up interval, a discharge is not generated between the scan electrodes Y and the sustain electrodes Z.

In other words, in the second half of the set-up interval, a discharge is generated only between the scan electrodes Y and the address electrodes X.

In other words, in the second half of the set-up interval, the sustain electrodes Z are floated, thereby preventing a surface discharge from occurring between the scan electrodes Y and the sustain electrodes Y. Accordingly, according to another conventional example, a brightness in the initialization period is lowered and hence a contrast is enhanced. Experimentally, when the PDP is driven in a driving method as described in FIG. 3, a light of approximately 1.3 cd/m² is generated during the reset period. On the other hand, when the PDP is driven in a driving method as described in FIG. 5, a light of approximately 1.0 cd/m² is generated during the reset period. If the sustain electrodes Z are floated in the second half of the set-up interval, then an amount of wall charges formed in the set-up interval becomes smaller than the method of driving the PDP as shown in FIG. 3.

Meanwhile, in the second half of the set-up interval when the sustain electrodes Z keep a floating state, a certain voltage is derived into the sustain electrodes Z. In other words, a certain voltage corresponding to a voltage value applied to the scan electrodes Y in the second half of the set-up interval is derived into the sustain electrodes Z.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage Zdc having a sustain voltage level Vs is applied to the sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied.

However, the PDP according to another conventional example driven as mentioned above raises a miswriting and a misfire at the sub-fields having a high brightness weighting value. In other words, in an operation experiment of another conventional example, the sub-fields having a low brightness weighting value make a stable driving while the sub-fields having a high brightness weighting value cause a miswriting and a misfire. It has been predicted that such miswriting or misfire phenomenon occurs because a large amount of loads are applied to the PDP when a brightness weighting value is high.

### SUMMARY OF THE INVENTION

Accordingly, it is an object of the present invention to provide a method of driving a plasma display panel that is adaptive for preventing a miswriting and a misfire as well as improving a contrast.

In order to achieve these and other objects of the invention, a method of driving a plasma display panel according to one embodiment of the present invention includes the steps of applying a first waveform to sustain electrodes in an initialization period included in an initial sub-field of one frame; and applying a second waveform to the sustain electrodes in an initialization period of each of the remaining sub-fields following the initial sub-field.

In the method, said initial sub-field is at least one sub-field including the first sub-field of said frame.

Herein, said initial sub-field is the first and second sub-fields of said frame.

Each of the remaining sub-fields other than the initial sub-field has a higher brightness weighting value than the initial sub-field.

Said initialization period of the initial sub-field includes a set-up interval for forming wall charges within cells by a writing discharge, and a set-down interval for erasing a portion of said wall charges by an erasure discharge; and the sustain electrodes are electrically floated during a first time interval that is a portion of said set-up interval.

Herein, each of said initialization periods of the remaining sub-fields other than the initial sub-field includes a set-up interval for forming wall charges within cells by a writing discharge, and a set-down interval for erasing a portion of said wall charges by an erasure discharge; and the sustain electrodes are supplied with a ground voltage during the set-up interval.

On the other hand, each of said initialization periods of the remaining sub-fields other than the initial sub-field includes a set-up interval for forming wall charges within cells by a writing discharge, and a set-down interval for erasing a portion of said wall charges by an erasure discharge; and the sustain electrodes are electrically floated during a shorter time than said first time interval in the set-up interval.

Herein, a time interval when the sustain electrode is floated is set to be shorter as it goes into the last sub-field of said frame.

A voltage rising at a first slope is derived into the sustain electrode during said first time interval.

Alternatively, each of said initialization periods of the remaining sub-fields other than the initial sub-field includes a set-up interval for forming wall charges within cells by a writing discharge, and a set-down interval for erasing a portion of said wall charges by an erasure discharge; and a voltage rising at a lower slope than said first slope is applied to the sustain electrode during said first time interval.

Herein, said voltage applied to the sustain electrode is set to have a lower slope as it goes into the last sub-field of said frame.

A method of driving a plasma display panel according to another embodiment of the present invention includes the steps of applying a first waveform to sustain electrodes in an initialization period of a sub-field having a low weighting value at one frame; and applying a second waveform to the sustain electrodes in an initialization period of each of the remaining sub-fields other than the initial sub-field having said low brightness weighting value.

In the method, said sub-field having said low brightness weighting value includes at least one sub-field having a brightness weighting value that is less than a half of the maximum brightness weighting value of said frame.

Said initialization period of said sub-field having said low brightness weighting value includes a set-up interval for forming wall charges within cells by a writing discharge, and a set-down interval for erasing a portion of said wall charges by an erasure discharge; and the sustain electrodes are electrically floated during a first time interval that is a portion of said set-up interval.

Herein, each of said initialization periods of the remaining sub-fields other than said sub-field having said low brightness weighting value includes a set-up interval for forming wall charges within cells by a writing discharge, and a set-down interval for erasing a portion of said wall charges by an erasure discharge; and the sustain electrodes are supplied with a ground voltage in the set-up interval.

Alternatively, each of said initialization periods of the remaining sub-fields other than said sub-field having said low brightness weighting value includes a set-up interval for forming wall charges within cells by a writing discharge, and a set-down interval for erasing a portion of said wall charges by an erasure discharge; and the sustain electrodes are electrically floated during a shorter time than said first time interval in the set-up interval.

Herein, a time interval when the sustain electrode is floated is set to be shorter as it goes into a sub-field having a higher brightness weighting value.

A voltage rising at a first slope is derived into the sustain electrode during said first time interval.

Alternatively, each of said initialization periods of the remaining sub-fields other than said sub-field having said low brightness weighting value includes a set-up interval for forming wall charges within cells by a writing discharge, and a set-down interval for erasing a portion of said wall charges by an erasure discharge; and a voltage rising at a lower slope than said first slope is applied to the sustain electrode during said first time interval.

Herein, said voltage applied to the sustain electrode is set to have a lower slope as it goes into a sub-field having a higher brightness weighting value.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a discharge cell structure of a conventional three-electrode, AC surface-discharge plasma display panel;

FIG. 2 illustrates one frame in the conventional AC surface-discharge plasma display panel;

FIG. 3 is a waveform diagram of driving signals supplied to the electrodes during the sub-field shown in FIG. 2;

FIG. 4 depicts wall charges formed at the electrodes in the initialization period;

FIG. 5 is a waveform diagram for explaining another conventional method of driving the plasma display panel;

FIG. 6 is a waveform diagram for explaining a method of driving a plasma display panel according to a first embodiment of the present invention;

FIG. 7A and FIG. 7B illustrate voltage differences generated in the initialization period by a driving waveform shown in FIG. 6;

FIG. 8 is a waveform diagram for explaining a method of driving a plasma display panel according to a second embodiment of the present invention;

FIG. 9A and FIG. 9B illustrate voltage differences generated in the initialization period by a driving waveform shown in FIG. 8;

FIG. 10 is a waveform diagram for explaining a method of driving a plasma display panel according to a third embodiment of the present invention; and

FIG. 11A and FIG. 11B illustrate voltage differences generated in the initialization period by a driving waveform shown in FIG. 10.

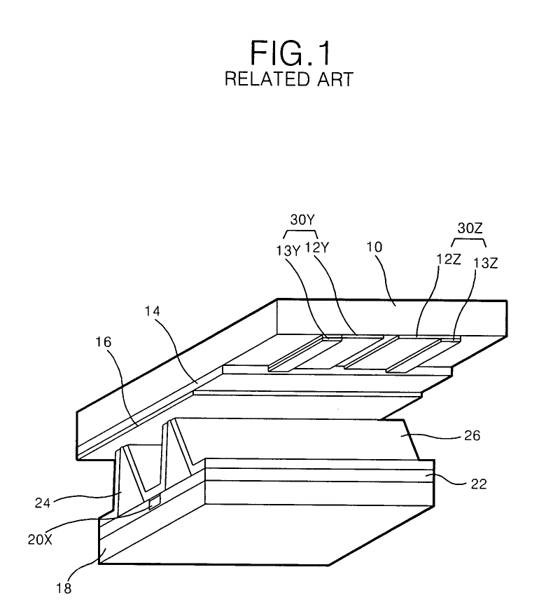

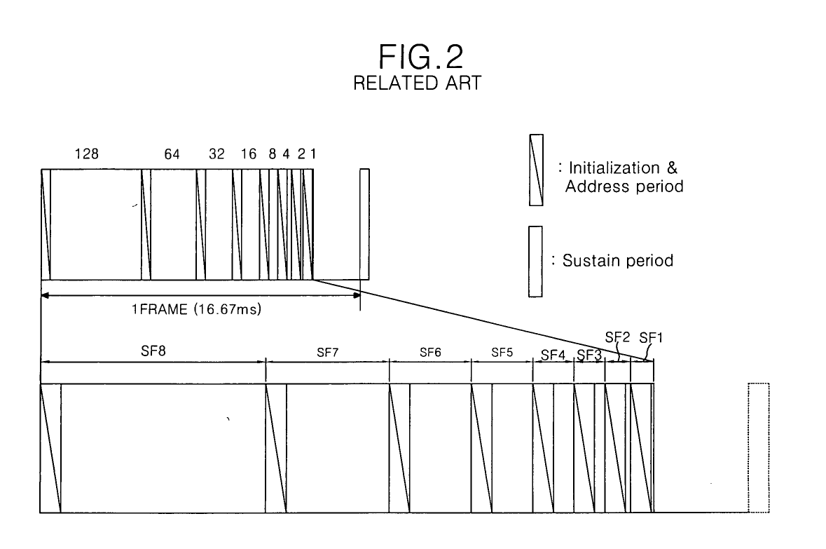

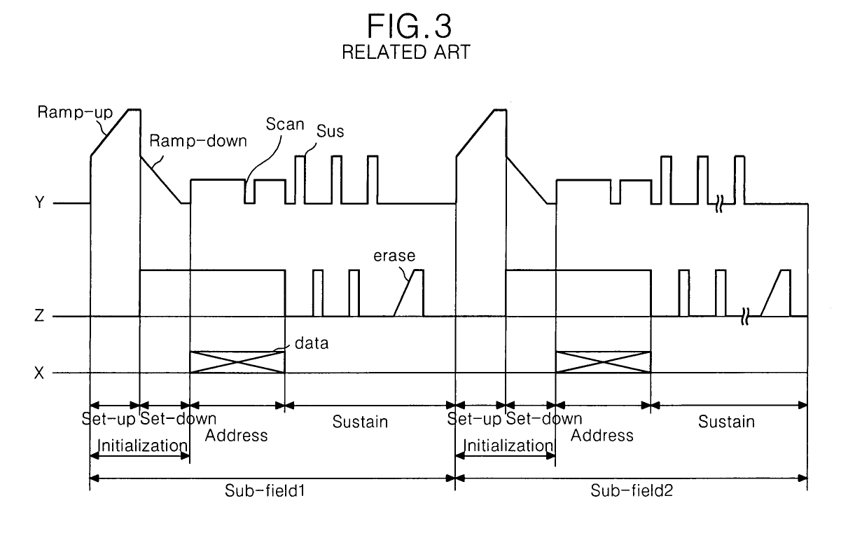

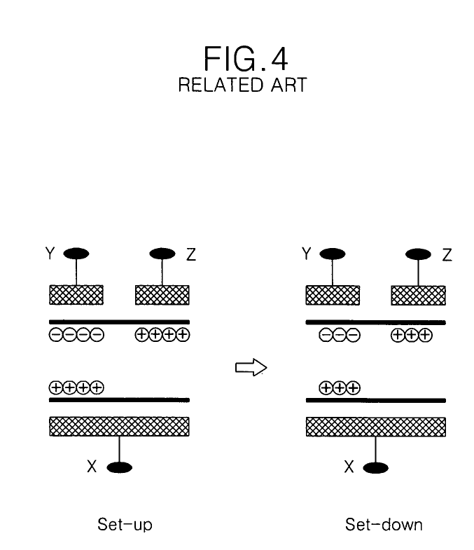

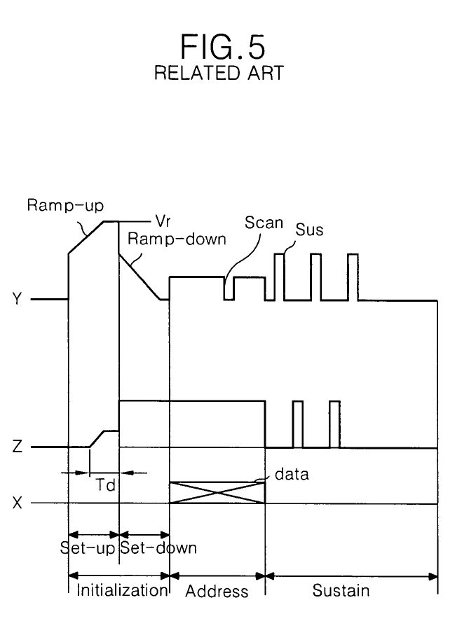

### DETAILED DESCRIPTION OF THE PREFERRED EMBODIMENT

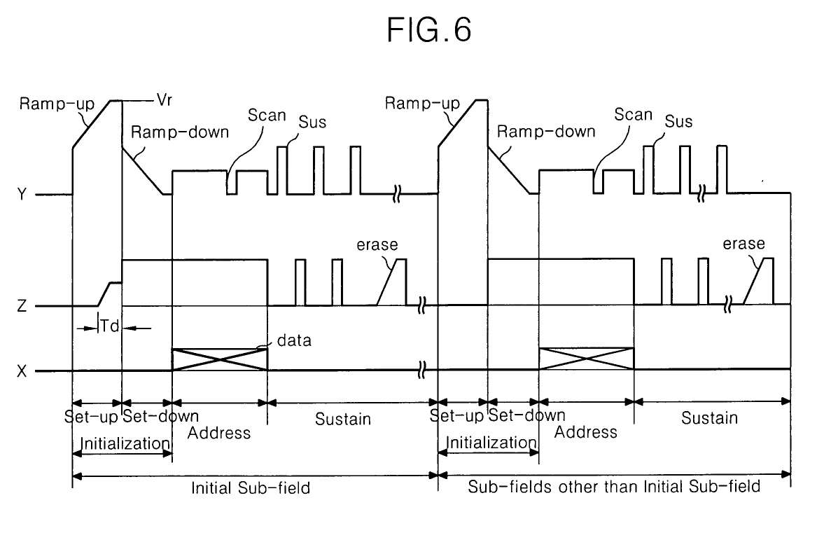

FIG. 6 shows a method of driving a plasma display panel (PDP) according to a first embodiment of the present invention.

Referring to FIG. 6, in the PDP according to the first embodiment of the present invention, a driving waveform applied to an initial sub-field is set to be different from driving pulses applied to sub-fields other than the initial sub-field.

First, the initial sub-field is divided into an initialization period for initializing the entire field, an address period for selecting a cell and a sustain period for sustaining a discharge of the selected cell for its driving. Herein, the initial field means at least one sub-field including the first sub-field, for example, the first and second sub-fields. In other words, the initial sub-field means a sub-field having a low brightness weighting value. Herein, the sub-field having a low brightness weighting value means at least one sub-field having a brightness weighting value less than a half (½) of the maximum brightness weighting value.

In the initialization period, a rising ramp waveform Ramp-up is simultaneously applied to all of scan electrodes Y in a set-up interval. This rising ramp waveform Ramp-up causes a weak discharge within cells at the full field to generate wall charges within the cells. In the set-down interval, after the rising ramp waveform Ramp-up was raised into a peak voltage Vr, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, the sustain electrodes Z are floated. In the first half of the set-up interval when the sustain electrodes Z are supplied with a ground voltage, a discharge is generated between the scan electrodes Y and the sustain electrodes Z to thereby form wall charges within the discharge cell. In the second half of the set-up interval when the sustain electrodes Z are floated (i.e., a time interval less than a half (½) of the entire set-up interval), a discharge is not generated between the scan electrodes Y and the sustain electrodes Z. In other words, in the second half of the set-up interval, a discharge is generated only between the scan electrodes Y and the address electrodes X.

In other words, in the set-up interval of the initial sub-field, the sustain electrodes Z are floated, thereby preventing a surface discharge from occurring between the scan electrodes Y and the sustain electrodes Y. Accordingly, a brightness of a light generated in the reset period upon operation of the initial sub-field can be lowered and hence a contrast can be enhanced.

Meanwhile, in the second half of the set-up interval when the sustain electrodes Z keep a floating state, a certain voltage is derived into the sustain electrodes Z. In other words, a voltage corresponding to a voltage value applied to the scan electrodes Y in the second half of the set-up interval is derived into the sustain electrodes Z.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

On the other hand, each of the sub-fields other than the initial sub-field (i.e., the sub-fields having a high brightness weighting value) is divided into an initialization period for initializing the entire field, an address period for selecting a cell and a sustain period for sustaining a discharge of the selected cell for its driving.

In the initialization period, a rising ramp waveform Ramp-up is simultaneously applied to all of scan electrodes Y in a set-up interval. This rising ramp waveform Ramp-up causes a weak discharge within cells at the full field to generate wall charges within the cells. In the set-up interval, a ground voltage is applied to the sustain electrode Z. In other words, the sustain electrode Z is not floated at the sub-fields other than the initial sub-field. If the sustain electrode Z is not floated as mentioned above, then a high voltage difference is generated between the scan electrode Y and the sustain electrode Z to thereby cause a stable fine discharge within the cell.

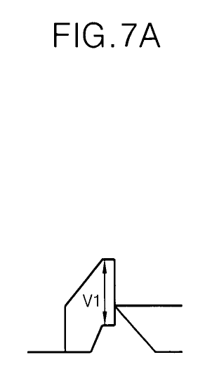

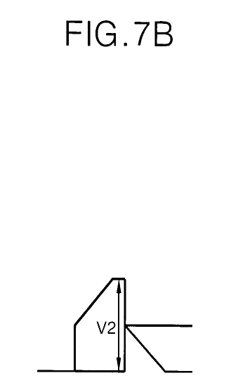

More specifically, first, the sustain electrode Z is floated during the second half of the set-up interval at the initial sub-field. If the sustain electrode Z is floated, then a voltage difference V1 is generated between the scan electrode Y and the sustain electrode Z as shown in FIG. 7A. In FIG. 7A, the solid line represents a voltage applied to the scan electrode Y, and the dotted line does a voltage derived into the sustain electrode Z.

On the other hand, the sustain electrode Z is not floated during the second half of the set-up interval at the sub-fields other than the initial sub-field. If the sustain electrode Z is not floated, then a voltage difference V2 higher than the voltage difference V1 is generated between the scan electrode Y and the sustain electrode Z as shown in FIG. 7B. Accordingly, the sub-fields other than the initial sub-field having a high brightness weighting value can cause a stable set-up discharge. In other words, the above-mentioned embodiment of the present invention floats the sustain electrode at the initial sub-field to thereby enhance a contrast while it does not float the sustain electrode Z at the sub-fields other than the initial sub-field to thereby cause a stable set-up discharge. As a result, the embodiment of the present invention can prevent a miswriting as well as a misfire.

In the set-down interval, after the rising ramp waveform Ramp-up was applied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

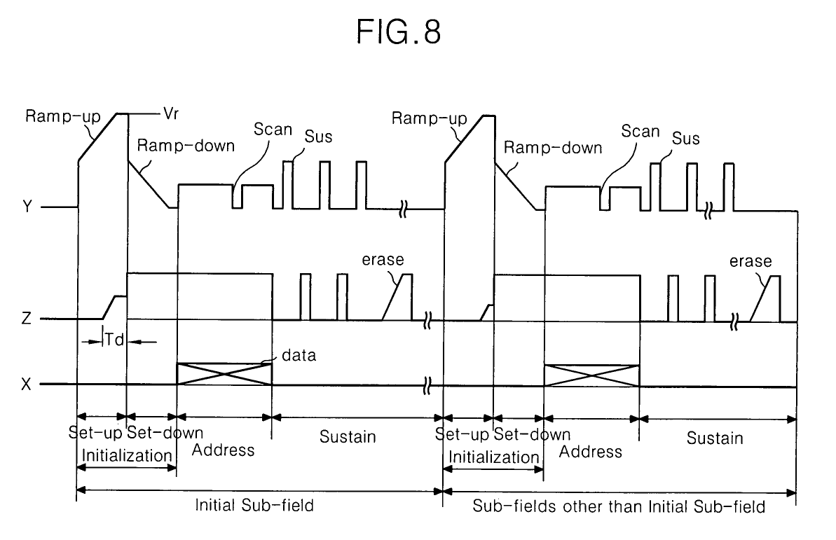

FIG. 8 shows a method of driving a PDP according to a second embodiment of the present invention.

Referring to FIG. 8, in the PDP according to the second embodiment of the present invention, a driving waveform applied to an initial sub-field is set to be different from driving pulses applied to sub-fields other than the initial sub-field.

First, the initial sub-field is divided into an initialization period for initializing the entire field, an address period for selecting a cell and a sustain period for sustaining a discharge of the selected cell for its driving. Herein, the initial field means the first sub-field, preferably, the first and second sub-fields. In other words, the initial sub-field means a sub-field having a low brightness weighting value.

In the initialization period, a rising ramp waveform Ramp-up is simultaneously applied to all of scan electrodes Y in a set-up interval. This rising ramp waveform Ramp-up causes a weak discharge within cells at the full field to generate wall charges within the cells. Further, after the rising ramp waveform Ramp-up was raised into a peak voltage Vr in the set-up interval, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, the sustain electrodes Z are floated. In the first half of the set-up interval when the sustain electrodes Z are supplied with a ground voltage, a discharge is generated between the scan electrodes Y and the sustain electrodes Z to thereby form wall charges within the discharge cell. In the second half of the set-up interval when the sustain electrodes Z are floated, a discharge is not generated between the scan electrodes Y and the sustain electrodes Z. In other words, in the second half of the set-up interval, a discharge is generated only between the scan electrodes Y and the address electrodes X.

In other words, in the set-up interval of the initial sub-field, the sustain electrodes Z are floated, thereby preventing a surface discharge from occurring between the scan electrodes Y and the sustain electrodes Y. Accordingly, a brightness of a light generated in the reset period upon operation of the initial sub-field can be lowered and hence a contrast can be enhanced.

Meanwhile, in the second half of the set-up interval when the sustain electrodes Z keep a floating state, a certain voltage is derived into the sustain electrodes Z. In other words, with the aid of the rising ramp waveform Ramp-up applied to the scan electrodes Y in the second half of the set-up interval and a time interval when the peak voltage Vr is kept, a predetermined voltage is derived into the sustain electrodes Z.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

On the other hand, each of the sub-fields other than the initial sub-field (i.e., the sub-fields having a high brightness weighting value) is divided into an initialization period for initializing the entire field, an address period for selecting a cell and a sustain period for sustaining a discharge of the selected cell for its driving.

In the initialization period, a rising ramp waveform Ramp-up is simultaneously applied to the entire scan electrodes Y in a set-up interval. This rising ramp waveform Ramp-up causes a weak discharge within cells at the full field to generate wall charges within the cells. Further, after the rising ramp waveform Ramp-up was raised into a peak voltage Vr in the set-up interval, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, the sustain electrodes Z are floated. In the first half of the set-up interval when the sustain electrodes Z are supplied with a ground voltage, a discharge is generated between the scan electrodes Y and the sustain electrodes Z to thereby form wall charges within the discharge cell. In the second half of the set-up interval when the sustain electrodes Z are floated, a discharge is not generated between the scan electrodes Y and the sustain electrodes Z. In other words, in the second half of the set-up interval, a discharge is generated only between the scan electrodes Y and the address electrodes X.

Meanwhile, a time when the sustain electrodes Z are floated in the set-up intervals of the sub-fields other than the initial sub-field is set to be shorter than a time when the sustain electrodes Z are floated in the set-up interval of the initial sub-field. For instance, the sustain electrodes Z are floated during a first time at the initial sub-field, whereas the sustain electrodes Z are floated during a second time shorter than the first time at the sub-fields other than the initial sub-field. Herein, various methods are applicable to the floating of the initial sub-field and the sub-fields other than the initial sub-field. For example, as it goes from the initial sub-field into the later sub-fields, that is, as it goes from the sub-field having a low brightness weighting value into the sub-field having a high brightness weighting value, a time for floating the sustain electrodes Z can be set more shortly.

If a time when the sustain electrodes Z are floated at the sub-fields other than the initial sub-field is set shortly as mentioned above, then a high voltage difference can be generated between the scan electrode Y and the sustain electrode Z to thereby cause a stable discharge within the cell.

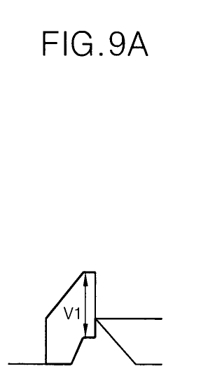

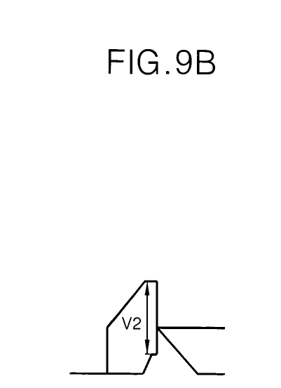

More specifically, first, the sustain electrode Z is floated during the first time in the second half of the set-up interval at the initial sub-field. If the sustain electrode Z is floated during the first time, then a voltage difference V1 is generated between the scan electrode Y and the sustain electrode Z as shown in FIG. 9A. In FIG. 9A, the solid line represents a voltage applied to the scan electrode Y, and the dotted line does a voltage applied to the sustain electrode Z.

On the other hand, the sustain electrode Z is floated during the second time shorter than the first time in the second half of the set-up interval at the sub-fields other than the initial sub-field. If the sustain electrode Z is floated during the second time, then a voltage difference V2 higher than the voltage difference V1 is generated between the scan electrode Y and the sustain electrode Z as shown in FIG. 9B. Accordingly, the sub-fields other than the initial sub-field having a high brightness weighting value can cause a stable set-up discharge. In other words, the above-mentioned embodiment of the present invention floats the sustain electrode during the first time at the initial sub-field to thereby enhance a contrast while it floats the sustain electrode Z the second time shorter than the first time at the sub-fields other than the initial sub-field to thereby cause a stable set-up discharge. As a result, the embodiment of the present invention can prevent a miswriting as well as a misfire. Experimentally, in the embodiment of the present invention, a light of approximately 0.8 cd/m² lower than the prior art is generated during the reset period at the sub-fields other than the initial sub-field.

In the set-down interval, after the rising ramp waveform Ramp-up was applied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

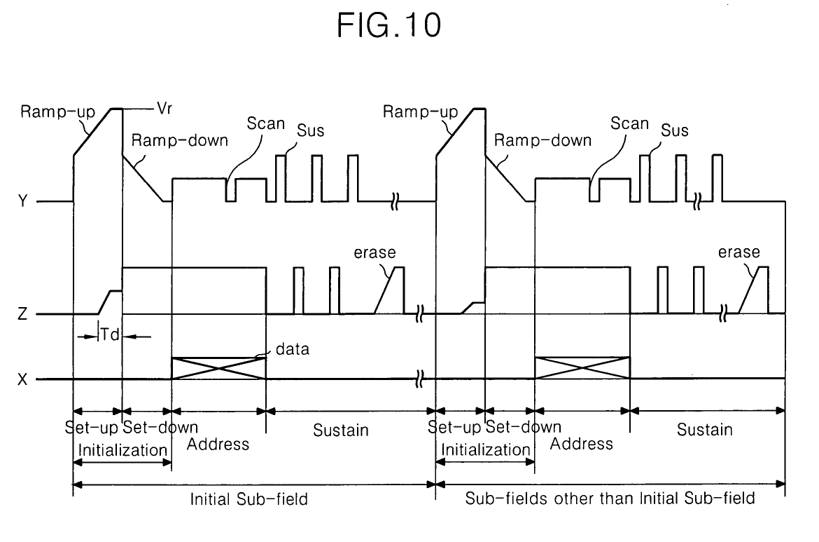

FIG. 10 shows a method of driving a PDP according to a third embodiment of the present invention.

Referring to FIG. 10, in the PDP according to the third embodiment of the present invention, a driving waveform applied to an initial sub-field is set to be different from driving pulses applied to sub-fields other than the initial sub-field.

First, the initial sub-field is divided into an initialization period for initializing the entire field, an address period for selecting a cell and a sustain period for sustaining a discharge of the selected cell for its driving. Herein, the initial field means the first sub-field, preferably, the first and second sub-fields. In other words, the initial sub-field means a sub-field having a low brightness weighting value.

In the initialization period, a rising ramp waveform Ramp-up is simultaneously applied to all of scan electrodes Y in a set-up interval. This rising ramp waveform Ramp-up causes a weak discharge within cells at the full field to generate wall charges within the cells. Further, after the rising ramp waveform Ramp-up was raised into a peak voltage Vr in the set-up interval, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, the sustain electrodes Z are floated. In the first half of the set-up interval when the sustain electrodes Z are supplied with a ground voltage, a discharge is generated between the scan electrodes Y and the sustain electrodes Z to thereby form wall charges within the discharge cell. In the second half of the set-up interval when the sustain electrodes Z are floated, a discharge is not generated between the scan electrodes Y and the sustain electrodes Z. In other words, in the second half of the set-up interval, a discharge is generated only between the scan electrodes Y and the address electrodes X.

In other words, in the set-up interval of the initial sub-field, the sustain electrodes Z are floated, thereby preventing a surface discharge from being generated between the scan electrodes Y and the sustain electrodes Y. Accordingly, a brightness of a light generated in the reset period upon operation of the initial sub-field can be lowered and hence a contrast can be enhanced.

Meanwhile, in the second half of the set-up interval when the sustain electrodes Z keep a floating state, a certain voltage is derived into the sustain electrodes Z. In other words, with the aid of the rising ramp waveform Ramp-up applied to the scan electrodes Y in the second half of the set-up interval and a time interval when the peak voltage Vr is kept, a predetermined voltage is derived into the sustain electrodes Z.

In the set-down interval, the falling ramp waveform Ramp-down is applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

On the other hand, each of the sub-fields other than the initial sub-field (i.e., the sub-fields having a high brightness weighting value) is divided into an initialization period for initializing the entire field, an address period for selecting a cell and a sustain period for sustaining a discharge of the selected cell for its driving.

In the initialization period, a rising ramp waveform Ramp-up is simultaneously applied to the entire scan electrodes Y in a set-up interval. This rising ramp waveform Ramp-up causes a weak discharge within cells at the full field to generate wall charges within the cells. Further, after the rising ramp waveform Ramp-up was raised into a peak voltage Vr in the set-up interval, the peak voltage Vr is applied to the scan electrodes Y during a predetermined time. If the peak voltage Vr of the rising ramp waveform Ramp-up is kept during a predetermined time, then wall charges formed in the discharge cell are intensified.

In the first half of the set-up interval, a ground voltage is applied to the sustain electrodes Z. On the other hand, in the second half of the set-up interval, a rising pulse having a predetermined slope is applied to the sustain electrodes Z. In the first half of the set-up interval when the sustain electrodes Z are supplied with the ground voltage, a discharge is generated between the scan electrodes Y and the sustain electrodes Z to thereby form wall charges within the discharge cell. In the second half of the set-up interval when the sustain electrodes Z are supplied with the rising pulse having a predetermined slope, a weak discharge is generated during the second half of the set-up interval when the rising pulse having a predetermined slope is applied to the sustain electrodes Z.

In other words, the rising pulse having a predetermined slope is applied to the sustain electrodes Z in the set-up intervals of the sub-fields other than the initial sub-field, thereby preventing a generation of a high brightness of discharge. Accordingly, a brightness of a light generated in the reset periods of the sub-fields other than the initial sub-field can be lowered and hence a contrast can be enhanced.

Meanwhile, the rising pulse applied to the sustain electrodes Z in the set-up intervals of the sub-fields other than the initial sub-field is set to have a slope lower than the voltage derived when the sustain electrodes Z are floated in the set-up interval of the initial sub-field. In other words, if a pulse having a first slope is derived into the sustain electrodes Z at the initial sub-field, then a rising pulse having a slope lower than the first slope is supplied to the sub-fields other than the initial sub-field. Herein, various methods are applicable to the supplying of the rising pulse into the sub-fields other than the initial sub-field. For example, as it goes from the initial sub-field into the later sub-fields, that is, as it goes from the sub-field having a low brightness weighting value into the sub-field having a high brightness weighting value, a rising pulse having a lower slope can be applied to the sustain electrodes Z.

If a rising pulse having a low slope is applied to the sustain electrode Z at the sub-fields other than the initial sub-field as mentioned above, then a high voltage difference can be generated between the scan electrode Y and the sustain electrode Z to thereby cause a stable fine discharge within the cell.

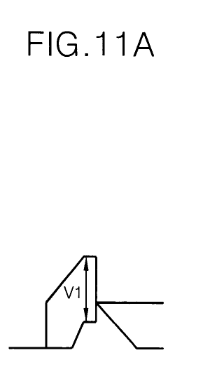

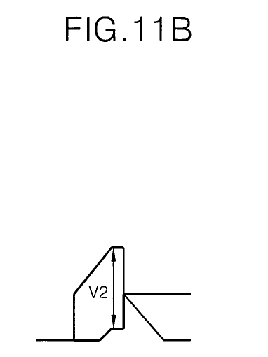

More specifically, first, the sustain electrode Z is floated during a first time in the second half of the set-up interval at the initial sub-field. If the sustain electrode Z is floated during the first time, then a voltage difference V1 is generated between the scan electrode Y and the sustain electrode Z as shown in FIG. 11A. In FIG. 11A, the solid line represents a voltage applied to the scan electrode Y, and the dotted line does a voltage applied to the sustain electrode Z.

On the other hand, a rising pulse having a low slope is applied to the sustain electrode Z during the second half of the set-up interval at the sub-fields other than the initial sub-field. If a rising pulse having a low slope is applied to the sustain electrode Z, then a voltage difference V2 higher than the voltage difference V1 is generated between the scan electrode Y and the sustain electrode Z as shown in FIG. 11B. Accordingly, the sub-fields other than the initial sub-field having a high brightness weighting value can cause a stable set-up discharge. In other words, the above-mentioned embodiment of the present invention floats the sustain electrode Z at the initial sub-field to thereby enhance a contrast while it applies the rising pulse having a low slope to the sustain electrode Z at the sub-fields other than the initial sub-field to thereby cause a stable set-up discharge. As a result, the embodiment of the present invention can prevent a miswriting as well as a misfire.

Experimentally, in the embodiment of the present invention, a light of approximately 0.8 cd/m lower than the prior art is generated during the reset period at the sub-fields other than the initial sub-field.

In the set-down interval, after the rising ramp waveform Ramp-up was applied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan is sequentially applied to the scan electrodes Y and, at the same time, a positive data pulse data is applied to the address electrodes X. A voltage difference between the scanning pulse scan and the data pulse data is added to a wall voltage generated in the initialization period to thereby generate an address discharge within the cells supplied with the data pulse data. Wall charges are formed within the cells selected by the address discharge.

Meanwhile, a positive direct current voltage having a sustain voltage level Vs is applied to the sustain electrodes Z during the set-down interval and the address period.

In the sustain period, a sustaining pulse sus is alternately applied to the scan electrodes Y and the common sustain electrodes Z. Then, a wall voltage within the cell selected by the address discharge is added to the sustain pulse sus to thereby generate a sustain discharge taking a surface-discharge type between the scan electrode Y and the sustain electrode Z whenever each sustain pulse sus is applied. Finally, after the sustain discharge has been finished, an erasing ramp waveform erase having a small pulse width is applied to the sustain electrode Z, thereby erasing wall charges within the cell.

As described above, according to the present invention, a pulse applied at the initial sub-field (i.e., the sub-field having a low brightness weighting value) is set to be different from pulses applied at the sub-fields other than the initial sub-field (i.e., the sub-fields having a high brightness weighting value). In other words, the sustain electrode is floated at the initial sub-field, thereby minimizing an amount of a light generated in the reset period. On the other hand, the sustain electrode is not floated at the sub-fields other than the initial sub-field, thereby causing a stable discharge. Accordingly, it becomes possible to preventing a miswriting and a misfire as well as enhancing a contrast.

Furthermore, according to the present invention, the sustain electrode is floated at the sub-fields other than the initial sub-field during a shorter time than the initial sub-field, thereby causing a stable discharge as well as enhancing a contrast. In addition, a pulse having a low slope is applied to the sustain electrode at the sub-fields other than the initial sub-field, thereby causing a stable discharge as well as enhancing a contrast.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method of driving a plasma display panel, comprising the steps of:
applying a first waveform to sustain electrodes in an initialization period included in an initial sub-field of one frame; and
applying a second waveform to the sustain electrodes in an initialization period of each of the remaining sub-fields following the initial sub-field.

2. The method as claimed in claim 1, wherein said initial sub-field is at least one sub-field including the first sub-field of said frame.

3. The method as claimed in claim 2, wherein said initial sub-field is the first and second sub-fields of said frame.

4. The method as claimed in claim 1, wherein each of the remaining sub-fields other than the initial sub-field has a higher brightness weighting value than the initial sub-field.

5. The method as claimed in claim 1, wherein said initialization period of the initial sub-field includes a set-up interval for forming wall charges within cells by a writing discharge, and a set-down interval for erasing a portion of said wall charges by an erasure discharge, and wherein the sustain electrodes are electrically floated during a first time interval that is a portion of said set-up interval.

6. The method as claimed in claim 5, wherein each of said initialization periods of the remaining sub-fields other than the initial sub-field includes a set-up interval for forming wall charges within cells by a writing discharge, and a set-down interval for erasing a portion of said wall charges by an erasure discharge, and wherein the sustain electrodes are supplied with a ground voltage during the set-up interval.

7. The method as claimed in claim 5, wherein each of said initialization periods of the remaining sub-fields other than the initial sub-field includes a set-up interval for forming wall charges within cells by a writing discharge, and a set-down interval for erasing a portion of said wall charges by an erasure discharge, and wherein the sustain electrodes are electrically floated during a shorter time than said first time interval in the set-up interval.

8. The method as claimed in claim 7, wherein a time interval when the sustain electrode is floated is set to be shorter as it goes into the last sub-field of said frame.

9. The method as claimed in claim 5, wherein a voltage rising at a first slope is derived into the sustain electrode during said first time interval.

10. The method as claimed in claim 9, wherein each of said initialization periods of the remaining sub-fields other than the initial sub-field includes a set-up interval for forming wall charges within cells by a writing discharge, and a set-down interval for erasing a portion of said wall charges by an erasure discharge, and wherein a voltage rising at a lower slope than said first slope is applied to the sustain electrode during said first time interval.

11. The method as claimed in claim 10, wherein said voltage applied to the sustain electrode is set to have a lower slope as it goes into the last sub-field of said frame.

12. A method of driving a plasma display panel, comprising the steps of:
applying a first waveform to sustain electrodes in an initialization period of a sub-field having a low weighting value at one frame; and
applying a second waveform to the sustain electrodes in an initialization period of each of the remaining sub-fields other than the initial sub-field having said low brightness weighting value.

13. The method as claimed in claim 12, wherein said sub-field having said low brightness weighting value includes at least one sub-field having a brightness weighting value that is less than a half of the maximum brightness weighting value of said frame.

14. The method as claimed in claim 12, wherein said initialization period of said sub-field having said low brightness weighting value includes a set-up interval for forming wall charges within cells by a writing discharge, and a set-down interval for erasing a portion of said wall charges by an erasure discharge, and wherein the sustain electrodes are electrically floated during a first time interval that is a portion of said set-up interval.

15. The method as claimed in claim 14, wherein each of said initialization periods of the remaining sub-fields other than said sub-field having said low brightness weighting value includes a set-up interval for forming wall charges within cells by a writing discharge, and a set-down interval for erasing a portion of said wall charges by an erasure discharge, and wherein the sustain electrodes are supplied with a ground voltage in the set-up interval.

16. The method as claimed in claim 14, wherein each of said initialization periods of the remaining sub-fields other than said sub-field having said low brightness weighting value includes a set-up interval for forming wall charges within cells by a writing discharge, and a set-down interval for erasing a portion of said wall charges by an erasure discharge, and wherein the sustain electrodes are electrically floated during a shorter time than said first time interval in the set-up interval.

17. The method as claimed in claim 16, wherein a time interval when the sustain electrode is floated is set to be shorter as it goes into a sub-field having a higher brightness weighting value.

18. The method as claimed in claim 14, wherein a voltage rising at a first slope is derived into the sustain electrode during said first time interval.

19. The method as claimed in claim 18, wherein each of said initialization periods of the remaining sub-fields other than said sub-field having said low brightness weighting value includes a set-up interval for forming wall charges within cells by a writing discharge, and a set-down interval for erasing a portion of said wall charges by an erasure discharge, and wherein a voltage rising at a lower slope than said first slope is applied to the sustain electrode during said first time interval.

20. The method as claimed in claim 19, wherein said voltage applied to the sustain electrode is set to have a lower slope as it goes into a sub-field having a higher brightness weighting value.
